(19) United States
(12) Patent Application Publication
(10) Pub. No.: US 2010/0111248 A1
(43) Pub. Date: May 6, 2010

(54) APPARATUS, IMAGING DEVICE AND METHOD FOR COUNTING X-RAY PHOTONS

(75) Inventors: Christian Baeumer, Hergenrath (BE); Christoph Herrmann, Aachen (DE); Roger Steadman Booker, Aachen (DE); Guenter Zeitler, Aachen (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/528,632

(22) PCT Filed: Feb. 22, 2008
(86) PCT No.: PCT/IB2008/050648

§ 371 Date: Aug. 26, 2009

(30) Foreign Application Priority Data
Feb. 27, 2007 (EP) 07103143.9

(51) Int. Cl. G21K 1/10

(52) U.S. Cl. 378/19

(57) ABSTRACT

The invention relates to an apparatus (10) for counting X-rayphotons (12, 14), in particular photons in a computer tomograph. The events from a first photon-sensitive element (20) are recorded in a first integrator (24), and the events coming from a second photon-sensitive element (22) are counted in a second integrator (26). A first summing unit (28) is provided for summing the values from the first and second integrators (24, 26) and a result signal to obtain a sum, wherein the result signal is obtained from a feedback device (30) being provided with the sum. It is there possible to reduce a total information density generated by the impinging photons (12, 14), so that a data stream with a reduced information density (or reduced data rate) is present at an output (34). The invention also relates to a corresponding imaging device (16) based on the detection of X-rayphotons (12, 14), in particular for medical use and to a method for counting X-rayphotons (12, 14), in particular photons in a computer tomograph.

### FIELD OF THE INVENTION

The present invention relates to an apparatus, an imaging device and a method for counting X-ray photons, in particular photons in a computer tomograph.

### BACKGROUND OF THE INVENTION

Computer tomography (CT, also called computed tomography) has evolved into a commonly used means, when it comes to generating a three-dimensional image of the internals of an object. The three-dimensional image is created based on a large number of two-dimensional X-ray images taken around a single axis of rotation. While CT is most commonly used for medical diagnosis of the human body, it has also been found applicable for non-destructive materials testing. Detailed information regarding the basics and the application of CT, can be found in the book “Computed Tomography” by Willi A. Kalender, ISBN 3-89578-216-5.

One of the key innovative aspects in future CT and X-ray imaging is the energy-resolved counting of the photons which are let through or transmitted by the object being analyzed when being exposed to X-ray radiation. Depending on the number and energy the transmitted photons have, it can be concluded through which type of material the X-ray radiation has traveled. In particular, this allows to identify different parts, tissues and materials within a human body.

As a general rule, it can be said, that the quality of the analysis result based on the information carried by the impinging photons can be improved by more accurately counting the number of impinging photons. However, attempting to accurately count the impinging photons, is accompanied by several issues.

One of the issues stems from the random distribution of the photons (Poisson distribution) in time. This can lead to a situation, where within the time window required to process a single photon a second photon arrives and interferes with the processing of the first photon, thereby leading to incorrect results. This situation is typically referenced as “pile-up of events”.

Since the quantum flow is very high, photon rates of up to 10⁹/(mm²·s) are common. This means that pile-up events occur with a significant likelihood and thus cannot be ignored.

In order to reduce the likelihood of an occurrence of pile-up events, an attempt has been made to reduce the size of the individual pixels of the sensor, thereby reducing the absolute number of photons impinging on a specific sensor element. However, this has led to another issue: If a pixel having an active surface of 1 mm×1 mm is replaced by 16 pixels with an area of 250 μm×250 μm the number of information channels increases by a factor of 16 which leads to a 16-fold increase in the information that has to be processed, requiring a significant effort to process and analyze this information.

One idea on how to deal with these constraints, is shown in the article “Low digital interference counter for photon-counting pixel detectors” by M. O'Neills, M. A. Abdalla, D. Oelmann, Nuclear Instruments and Methods in Physics Research A 487 (2002), pages 323-330, where an event counter architecture aims to decrease the digital switching and power consumption in a pixel.

### SUMMARY OF THE INVENTION

It is an object of the present invention to provide an apparatus for counting X-ray photons, in particular photons in a computer tomograph having a less extensive architecture which still delivers the desired counting accuracy. It is a further object of the present invention to provide a corresponding imaging device based on the counting of X-ray photons, in particular for medical use. It is yet another object of the present invention to provide an improved method for counting X-ray photons, in particular photons in a computer tomograph.

According to one aspect of the invention this is achieved by an apparatus for counting X-ray photons, in particular photons in a computer tomograph, comprising an arrangement adapted to convert impinging photons into countable events and having at least a first photon-sensitive element and a second photon-sensitive element, the apparatus further comprising an output adapted to provide information regarding the number of photons counted, at least a first integrator being coupled to the first photon-sensitive element and a second integrator being coupled to the second photon-sensitive element, further comprising a first summing unit for summing the output of the first and second integrators, the first summing unit being coupled to a feedback device providing a result signal to the output, the result signal further being provided to the first summing unit and to the first and second integrators, so that a total information density generated by the impinging photons arrives as a reduced information density at the output.

According to another aspect of the invention this object is achieved by an imaging device based on the counting of X-ray photons, in particular for medical use, comprising an apparatus as described before. Such an imaging device is in particular embodied as an X-ray machine, a computer tomograph, a device for nuclear medicine techniques (e.g. positron emission tomography or single photon emission computed tomography) or any other radiography device.

According to yet another aspect of the invention this object is achieved by a method for counting X-ray photons, in particular photons in a computer tomograph, comprising the following steps:

converting photons impinging on at least a first photon-sensitive element into first countable events and providing the events to at least a first integrator;

converting photons impinging on a second photon-sensitive element into second countable events and providing the events to a second integrator;

summing first and second countable events and a result signal to obtain a sum, wherein the result signal is obtained from a feedback device being provided with the sum;

providing the result signal to the first and second integrators, so that a total information density generated by the impinging photons is reduced.

This means that the apparatus according to the invention combines the information from at least two integrators which receive information from at least two photon-sensitive elements using the first summing unit. Furthermore, the feedback device which is coupled to the first summing unit, provides the result signal also to the two integrators in order to provide a feedback mechanism. It is the task of this feedback mechanism to reduce the information density generated by the impinging photons. Since the signal at the output of the apparatus has a reduced information density, the information generated by the impinging photons (location, time, energy) becomes easier to manage.

The feedback mechanism according to the present invention is comparable to a Sigma-Delta-converter, meaning that the output of the apparatus does not show the true absolute number for each of the photon-sensitive elements, but rather provides a continuous indication regarding how this absolute number changes.

This means, if the absolute number of photons does not drastically fluctuate over a short amount of time, a smaller amount of information is present at the output, than it is known from the prior art. Still, the absolute number can be recovered by continuously processing the output, namely the difference values present at the output.

It should be appreciated that the result signal being provided to the first summing unit can be modified before arriving at the first summing unit. In particular, a factor can be applied, typically a negative factor, and, if desired, the result signal can be delayed in time. The same is true concerning the result signal being provided to the first integrator and the result signal being provided to the second integrator.

There are many different possibilities on how to implement the feedback device and the overall feedback mechanism. Any specific implementation will largely depend on the choice of design and the overall characteristics the apparatus should achieve. Therefore, it is not possible to make a general recommendation. However, since the invention includes the concept of representing a stream of absolute numbers by a stream of relative differences, the well-known concepts of Sigma-Delta-modulator design can be applied, at least as a starting point.

Another aspect that helps to reduce the total information density generated by the impinging photons is the fact that the outputs of the first integrator and the second integrator come together in the first summing unit. This means that the information as to whether a photon impinged on the first photon-sensitive element or on the second photon-sensitive element is given up on purpose; yet, with the benefit of having to deal with (approximately) only half of the events being caused in each of the first and second photon-sensitive elements in comparison to having a combined element of first and second photon-sensitive elements being connected to just one integrator. It has been found that for certain applications this trade-off, which yields a reduced processing expenditure, is well-acceptable.

It should be appreciated that while mainly first and second integrators are discussed, the proposed concept can also be applied to three or more photon-sensitive elements and their respective integrators. In particular, this concept can be extended to a large number of pixels, e.g. to 16, 100 or more.

In a preferred embodiment the feedback device is embodied as an integrator.

If the first and second integrators are viewed as a first integrating stage (or simply, first stage), the feedback device can be viewed as a second integrating stage (or simply, second stage). Such an embodiment is comparable to a second order Sigma-Delta-modulator. It should be noted, however, that the feedback device can also comprise higher order integrating stages in order to implement a feedback mechanism as can be found in third order (and higher) Sigma-Delta-converters.

In a further preferred embodiment of the invention a quantizer is arranged between the feedback device and the output.

In a further preferred embodiment the quantizer helps to further reduce the information density at the output. This embodiment bases on the finding that while an accurate counting is desired, it is not necessary to demand this precision down to the last digit. Therefore, depending on a reasonable resolution required, the quantizer discards information that is of little or no relevance for the subsequent analysis. Thereby, the information flow from the output of the apparatus becomes even more manageable.

In a further preferred embodiment the quantizer is embodied as a Hogenauer-type filter.

The Hogenauer-type filter is a well-known implementation of a comb filter and is described in the paper “A class of digital filters for decimation and interpolation”, by Eugene B. Hogenauer, IEEE Journal of Selected Topics in Quantum Electronics 5, 1980, CH1559-4/80/0000-0271, pages 271-274. It is an efficient decimation and low-pass filter, which has a sincⁿ frequency response for an n^{th} order filter. The Hogenauer-type filter has been found to be an effective means to reduce the information density at the output.

In particular, it can be beneficial to implement only the integrator-section of a Hogenauer-type filter, which is a cascade of n integrating registers for an n^{th} order filter having only half of the circuitry needed for a full Hogenauer-type filter. This implementation is especially beneficial, if the electronics area in the photon-sensitive elements (pixels) cannot accommodate a full Hogenauer-type filter. Nevertheless, even the integrator-section alone still provides the benefit of a decimated information density or data rate.

In a further preferred embodiment the first and second photon-sensitive elements are sub-pixels of a larger macro-pixel.

This embodiment proposes to provide a combined information from a macro-pixel at the output of the apparatus, even though there is individual information available from each of the sub-pixels being associated with a macro-pixel. As an example, a macro-pixel having a size of 1 mm×1 mm can comprise 100 sub-pixels each having a size of 100 μm×100 μm. In this manner, the information density at the output can be reduced.

In a further preferred embodiment the result signal is provided to the first and second integrators via a second summing unit, which is further coupled to at least one of the first and second integrators.

A situation can occur, in which at least one of the first and second integrators has achieved a value, which is at or approaches the maximum value the integrator can represent. In this situation it is beneficial to reduce the value of the integrator and to provide a feedback to the second summing unit to compensate for this reduction. Since the second summing unit is preferably connected to the first and second integrators, the feedback based on the reduction is fed back to the first and second integrators.

In a further preferred embodiment of the invention, an A/D-converter is arranged between the sensor and the first and second integrators, the first and second integrators are embodied as digital registers and the feedback device is embodied using digital elements.

This embodiment allows to implement digital processing. While the photons impinging on the sensor trigger an analog charge pulse which is processed into an analog event, the A/D-converter provides a simple means to go from the analog domain into the digital domain. In the digital domain reliable digital components can be used that are less susceptive to noise and cross-talk.

In a further preferred embodiment of the invention at least the highest significant bit of the first and second integrators are fed back to the second summing element.

Since the first and second integrators will typically receive the same value (based on the result signal) it is likely that the values of the digital registers will diverge in the long term. This, however, can be compensated using this embodiment. The most significant bit or the most significant bits of the digital registers are regarded as overflow bits. If they contain a value of “1”, they are reset to “0” and this change is fed back to all registers through the feedback mechanism as will be explained in more detail later on.

In a further preferred embodiment the first and second integrators are operated asynchronously and the feedback device is operated synchronously.

The first and second integrators (digital registers) count any event representing an impinging photon regardless of the time when the event has occurred. The values of the integrators are read out in intervals determined by a clock cycle, and the first summing unit performs a summing action according to the clock cycle. The feedback device receives synchronous data and can be operated in synchronous mode. Therefore, this embodiment provides a simple yet effective means when having to bring the randomly distributed event caused by the photons into a format basing on a clock-cycle.

These and other aspects of the invention will be apparent from and elucidated with reference to the embodiments described hereinafter.

It is to be understood that the features mentioned above and those yet to be explained below can be used not only in the respective combinations but also in other combinations or as isolated features, without leaving the scope of the present invention.

### BRIEF DESCRIPTION OF THE DRAWINGS

Embodiments of the invention are shown in the drawings and will be explained in more detail in the description below with reference to the same, in which:

FIG. 1 shows a first embodiment of an apparatus according to the present invention for counting photons in an imaging device;

FIG. 2 shows a method for counting photons according to the present invention in computer tomograph;

FIG. 3 shows a second embodiment of an apparatus according to the present invention; and

FIG. 4 shows a programmatic example on how to operate the apparatus.

### DETAILED DESCRIPTION OF EXEMPLARY EMBODIMENTS

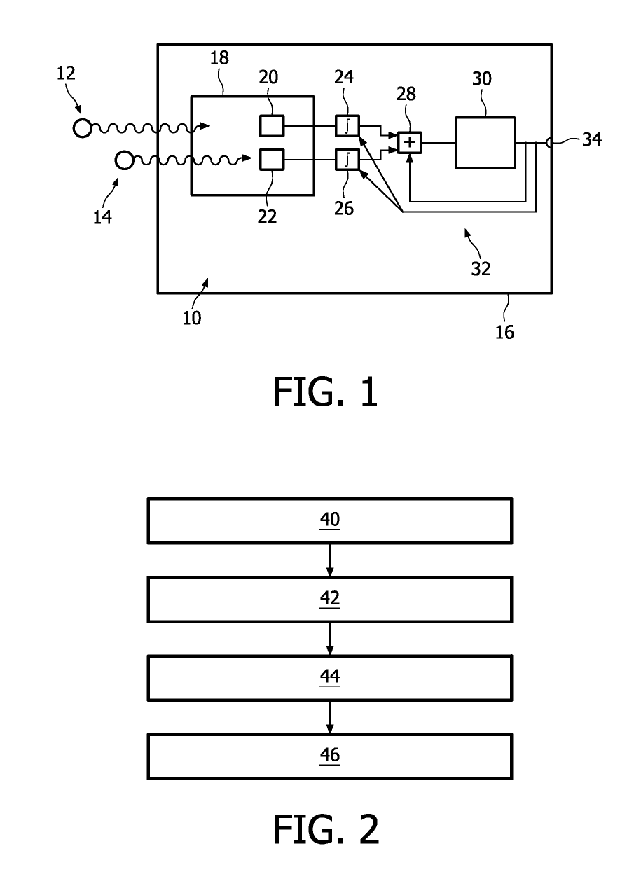

FIG. 1 shows a first embodiment of an apparatus 10 for counting X-ray photons 12, 14 in an imaging device 16, in particular embodied as a computer tomograph. The apparatus 10 comprises an arrangement 18 adapted to convert impinging photons 12, 14 into countable events.

The arrangement 18 has at least a first photon-sensitive element 20 and a second photon-sensitive element 22. The first and second photon-sensitive elements 20, 22 are coupled to first and second integrators 24, 26 respectively. It should be noted that the lines between the first and second photon-sensitive elements 20, 22 and the first and second integrators 24, 26 are not to be understood as a direct connection, since additional circuitry (not shown) well-known in the art is required to convert impinging photons into countable events.

A first summing unit 28 is provided for summing the output of the first and second integrators 24, 26 and also a result signal as will be described next.

The first summing unit 28 is coupled to a feedback device 30 which is part of a feedback mechanism 32. The feedback mechanism 32 is designed to reduce a total information density generated by the impinging photons 12, 14 to a reduced information density present at the output 34 of the apparatus 10.

In order to achieve this, the result signal being generated by the feedback device 30, is fed back to the first summing unit 28 and to the first and second integrators 24, 26. It should be noted, that the lines carrying the result signal and leading to the first summing unit 28 are not to be understood in a sense, that the result signal arrives unchanged at the first summing unit 28. Instead, the result signal will be multiplied by a certain factor, in particular a negative factor, in order to achieve the desired characteristics and a stable feedback mechanism 32. The same is true for the line going to the first and second integrators 24, 26. Typically, the factor for the result signal going to the first and second integrators 24, 26 is chosen equal, however, it is also possible, that two different factors are applied with regards to the first integrator 24 and the second integrator 26.

FIG. 2 shows a method for counting X-ray photons 12, 14 that can be applied to the apparatus 10 as shown in FIG. 1.

In step 40, photons that impinge on the first photon-sensitive element 20 are converted into first countable events, which are provided to the first integrator 24. In step 42 photons that impinge on the second photon-sensitive element 22 are converted into second countable events which are provided to the second integrator 26. There is no particular sequence regarding steps 40 and 42 and they are performed in arbitrary sequence and order depending on when and where photons impinge. In other words, these steps 40, 42 are performed asynchronously.

In step 44, the first and second countable events and a result signal are added in order to obtain a sum, wherein the result signal is obtained from the feedback device 30 being provided with the sum from the first summing unit 28. In step 46 the result signal is provided to the first and second integrators 24, 26. Overall, a total information density generated by the impinging photons is reduced.

Preferably, steps 44, 46 are performed with reference to a clock signal, so that an output signal which bases on a clock signal is present at the output 34.

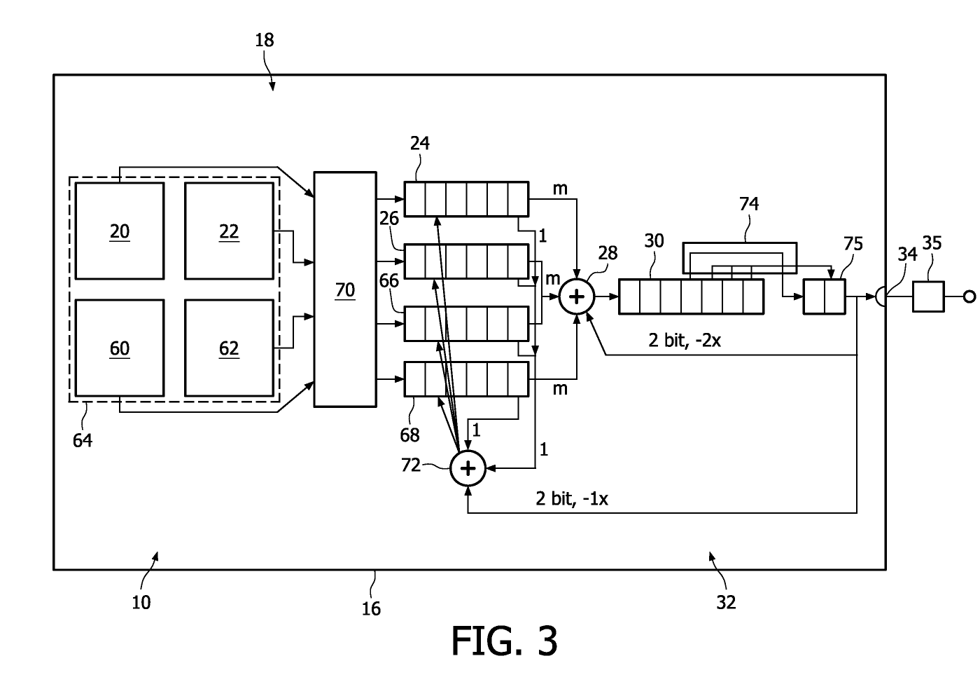

The structure and functionality of the apparatus 10 will now be described in more detail with reference to FIG. 3. First the structure of this second embodiment will be described, then the functionality of the apparatus 10 will be explained.

Apparatus 10 comprises first and second photon-sensitive elements 20, 22 and further third and fourth photon-sensitive elements 60, 62. These photon-sensitive elements 20, 22, 60, 62 are sub-pixels of a larger macro-pixel 64, which is indicated by the dashed line.

First, second, third and fourth photon-sensitive elements 20, 22, 60, 62 are respectively coupled to first, second, third and fourth integrators, 24, 26, 66, 68. Between the photon-sensitive elements 20, 22, 60, 62 and the integrators 24, 26, 66, 68 an A/D-converter 70 is arranged. The A/D-converter 70 individually processes the charge pulses from the photon-sensitive elements 20, 22, 60, 62 and outputs digital countable events to the respective integrators 24, 26, 66, 68.

The integrators 24, 26, 66, 68 are embodied as digital registers each having m bits. The counting in each of the integrators 24, 26, 66, 68 is done asynchronously and independent of the respective other integrators 24, 26, 66, 68. This means, that events provided to the integrators 24, 26, 66, 68 are counted regardless of their occurrence in time.

The values of the individual integrators 24, 26, 66, 68 (m bits) are provided to the first summing unit 28. The first summing unit 28 further receives a first quantized result signal as will be explained later on. Furthermore it should be noted, that the most significant bit (1 bit) of each integrator 24, 26, 66, 68 is provided to a second summing unit 72 which will also be explained later on.

The output of the first summing unit 28 is provided to the feedback device 30, which in this case is embodied as an integrator using digital elements. This means, that the feedback device 30 is also embodied as a digital register, in this case having n bits.

Due to the summing action performed by the first summing unit 28 based on a given clock cycle (not shown), it is obvious that the information density (or data rate) arriving at the feedback device 30 is reduced in comparison to the total information density generated by the impinging photons 12, 14. However, the information density can be decreased even further.

To achieve this, a result signal from the feedback device 30 is fed to a quantizer 74. In this case, the quantizer 74 has a size of 2 bits, wherein the most significant bit of the quantizer 74 corresponds to the first three most significant bits of the feedback device 30 and the least significant bit of the quantizer 74 corresponds to the fourth most significant bit of the feedback device 30. This means, when comparing the information density of the feedback device 30 and the quantizer 74, there is a reduction from n bits to 2 bits. The quantizer 74 is preferably embodied as a Hogenauer-type filter having a 2-bit-output.

The value or output of the quantizer 74 will be referred to as a master quantized result signal which is provided to the output 34 of the apparatus 10. Furthermore, the master quantized result signal is fed back with a factor of −2 as a first quantized result signal to the first summing unit 28 and by a factor of −1 to the second summing unit 72. These factors have been determined as beneficial for certain applications. However, these factors can vary if other design characteristics of the apparatus 10 and in particular of the feedback mechanism 32 are desired.

As briefly mentioned above, the second summing unit 72 also receives information representing the most significant bits of the integrators 24, 26, 66, 68. The output of the second summing unit 72 is fed back to all integrators 24, 26, 66, 68 in the same manner. While it would not be a typical design option, it is of course possible to individually modify the signal coming from the second summing unit 72 that is being sent to the integrators 24, 26, 66, 68.

The reason for feeding back the most significant bits of the integrators 24, 26, 66, 68 is as follows: During each clock cycle the same value, namely the output of the second summing unit 72 is fed back to the integrators 24, 26, 66, 68. It should be noted that the actual value being fed back to the individual integrators 24, 26, 66, 68 is the output of the second summing unit 72 divided by 4. This is necessary, since the result signal, and thereby the second quantized result signal, bases on the total value of four integrators 24, 26, 66, 68.

If no most significant bit is set, the output of the second summing unit 72 corresponds in this case to the negative master quantized result signal. In other words, for each clock cycle the master quantized result signal is subtracted from the integrators 24, 26, 66, 68. Since there is a certain tendency associated with each photon-sensitive element 20,22,60,62 and the respective integrators 24, 26, 66, 68, the values of the integrators 24, 26, 66, 68 will diverge in the long term.

To address this, the most significant bits of the integrators 24, 26, 66, 68 are used, specifically by regarding them as overflow bits. If a most significant bit is “1”, it is set to “0” and a corresponding correction is fed back to all integrators 24, 26, 66, 68 through the feedback mechanism 32 at the next clock cycle.

In the given case with four integrators 24, 26, 66, 68, the corresponding correction is determined by shifting the most significant bit by 2 bits to the left. This means, that the value represented by the most significant bit is divided by four. Since this correction is fed back to all four integrators 24, 26, 66, 68, the overall effect of clearing the most significant bit of one of the integrators 24, 26, 66, 68 is compensated. In a more generalized form, if k=2^{j} (j=2, 3 . . . ) integrators 24, 26, 66, 68 are used, the most significant bit is shifted j=log₂ k bits to the left.

A benefit of the present invention is that the information density (data rate or number of bits) at the output 34 is quite limited. Although the clock frequency (or sampling clock frequency) is quite high, the associated data rate is rather low.

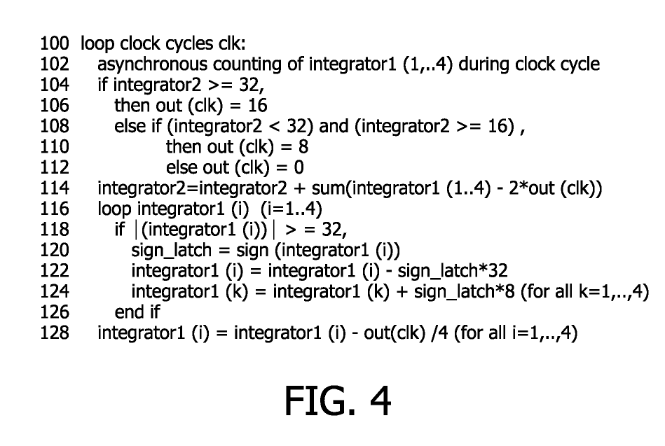

In order to explain the invention from a different perspective, reference is made to FIG. 4. It shows in programmatic terms how the apparatus 10 can be operated. However it should be noted, that FIG. 4 does not claim to be an executable code. Instead, it sketches an implementable concept that can be adapted to the specific implementation environment. Along these lines it should be understood, that the numbers provided are not intended to represent actual lines of code, but are rather used to reference the individual lines.

Line 100 represents the overall functionality of the apparatus 10. In particular a clock cycle clk is constantly applied. Line 102 shows that while the clock is running, an asynchronous counting is performed by the integrators 24, 26, 66, 68 which can be considered part of a first (integrating) stage.

Lines 104-112 represent a quantization step achieved by the quantizer 74 and based on the value of the feedback device 30, which can be understood as a second (integrating) stage. In particular, if the value of the feedback device 30 is greater than or equal to 32, the master quantized result signal will be set to a value of 16. If the value of the feedback device 30 is less than 32 yet greater than or equal to 16, the master quantized result signal will be set to a value of 8. Otherwise, this value will be set to 0.

Line 114 describes the functionality of the first summing unit 28, wherein the outputs of all integrators 24, 26, 66, 68 of a first stage are added and the first quantized result signal (being equal to the master quantized result signal multiplied by a factor −2) are added.

Lines 116-128 show a feedback loop involving the second summing unit 72. As indicated in line 116, the steps 118-128 are performed for each integrator 24, 26, 66, 68 of the first stage.

If the value of an integrator 24, 26, 66, 68 has an absolute value greater than or equal to 32, which in this example, represents an overflow condition, a processing according to lines 120-124 is performed, in order to address this situation:

First (line 120) it is determined, whether the overflow has taken place in the positive or the negative direction. Based on this result, the most significant bit is cleared (line 122) by either substracting a value of 32 or by adding a value of 32.

To compensate for clearing the most significant bit, each integrator 24, 26, 66, 68 is increased or decreased by a value of 8, which represents the result when shifting the value of 32 by 2 bits to the left. Since four integrators 24, 26, 66, 68 are used, this means that a compensation of 4×8=32 is performed and that the overflow of one of the integrators 24, 26, 66, 68 is addressed without changing the total combined value of all integrators 24, 26, 66, 68 of the first stage.

Finally, in line 128 the values of all integrators 24, 26, 66, 68 are changed based on the second quantized result signal (which in this case is simply the negative master quantized result signal) divided by 4.

In a technical implementation of the invention standard digital electronics technology can be applied. It is advantageous to use parallel adders. Also, a 2's complement representation can be used for the register contents of all integrators 24, 26, 66, 68 and the feedback device 30.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The terms “left”, “right”, etc. are used only for an eased understanding of the invention and do not limit the scope of the invention.

The mere fact that certain measures are recited in mutually different dependent claims does not indicate that a combination of these measures cannot be used to advantage. Any reference signs in the claims should not be construed as limiting the scope.

1. An apparatus for counting X-ray photons, in particular photons in a computer tomograph, comprising an arrangement adapted to convert impinging photons into countable events and having at least a first photon-sensitive element and a second photon-sensitive element, the apparatus further comprising an output adapted to provide information regarding the number of photons counted, at least a first integrator being coupled to the first photon-sensitive element and a second integrator being coupled to the second photon-sensitive element, further comprising a first summing unit for summing the output of the first and second integrators, the first summing unit being coupled to a feedback device providing a result signal to the output, the result signal further being provided to the first summing unit and to the first and second integrators, so that a total information density generated by the impinging photons arrives as a reduced information density at the output.

2. The apparatus according to claim 1, wherein the feedback device is embodied as an integrator.

3. The apparatus according to claim 1, wherein a quantizer is arranged between the feedback device and the output.

4. The apparatus according to claim 3, wherein the quantizer is embodied as a Hogenauer-type filter.

5. The apparatus according to claim 1, wherein the first and second photon-sensitive elements are sub-pixels of a larger macro-pixel.

6. The apparatus according to any preceding claim 1, wherein the result signal is provided to the first and second integrators via a second summing unit, which is further coupled to at least one of the first and second integrators.

7. The apparatus according to claim 1, wherein an A/D-converter is arranged between the first and second photon-sensitive elements and the first and second integrators, the first and second integrators are embodied as digital registers and the feedback device is embodied using digital elements.

8. The apparatus according to claim 7, wherein at least the most significant bit of the first and second integrators are fed back to the second summing element.

9. The apparatus according to claim 1, wherein the first and second integrators are operated asynchronously and the feedback device is operated synchronously.

10. An imaging device based on the detection of X-ray photons, in particular for medical use, comprising an apparatus according to claim 1.

11. A method for counting X-ray photons, in particular photons in a computer tomograph, comprising the following steps:
converting photons impinging on at least a first photon-sensitive element into first countable events and providing the events to at least a first integrator;
converting photons impinging on a second photon-sensitive element into second countable events and providing the events to a second integrator;
summing first and second countable events and a result signal to obtain a sum, wherein the result signal is obtained from a feedback device being provided with the sum;
providing the result signal to the first and second integrators, so that a total information density generated by the impinging photons is reduced.
